(19) United States
(12) Patent Application Publication
(10) Pub. No.: US 2025/0192403 A1
(43) Pub. Date: Jun. 12, 2025

(54) BUSBAR HOLDER AND BATTERY MODULE

(71) Applicant: SAMSUNG SDI CO., LTD., Yongin-si (KR)

(72) Inventors: Beom Jun WOO, Suwon-si (KR); Byung Hyun LEE, Suwon-si (KR); Sung Hyun JEON, Suwon-si (KR); Tae Ho JI, Suwon-si (KR)

(21) Appl. No.: 18/890,871

(22) Filed: Sep. 20, 2024

(30) Foreign Application Priority Data
Dec. 12, 2023 (KR) 10-2023-0179546

(51) Int. Cl. H01M 50/593; H01M 50/209; H01M 50/342; H01M 50/507; H01M 50/588

(52) U.S. Cl. CPC H01M 50/593; H01M 50/3425; H01M 50/507; H01M 50/588; H01M 50/209

(57) ABSTRACT

A busbar holder includes a holder base configured to support a plurality of busbars, each busbar electrically connecting a pair of adjacent battery cells among a plurality of battery cells, and an insulator which is fixed to the holder base and includes a plurality of cell vent covering portions configured to cover a plurality of cell vents provided to face a first direction in the plurality of battery cells and be ruptured when gases are discharged from inside to outside of the plurality of battery cells through the plurality of cell vents.

### CROSS-REFERENCE TO RELATED APPLICATION

The present application claims priority and the benefit of Korean Patent Application No. 10-2023-0179546, filed on Dec. 12, 2023 in the Korean Intellectual Property Office, the entire disclosure of which is incorporated herein by reference.

### BACKGROUND

### 1. Field

Embodiments relate to a busbar holder and a battery module including the busbar holder.

### 2. Discussion of Related Art

In general, as the demand for portable electronic products such as notebook computers, video cameras, and portable phones continues to increase, and the commercialization of robots, electric vehicles, and the like begins in earnest, research on high-performance secondary batteries repeatedly chargeable and dischargeable is being actively conducted.

Secondary batteries are widely used for driving or storing energy not only in small devices such as portable electronic devices, but also in medium and large devices such as electric vehicles and energy storage systems (ESSs). In particular, in the case of medium and large devices, in order to improve battery output power and/or capacity, a plurality of battery cells are electrically connected to each other to constitute a battery module.

Each battery cell may include a cell vent through which high-temperature and high-pressure gases and flammable materials generated internally due to an abnormal phenomenon that occurs during charging or discharging are discharged. Gases and flammable materials discharged from some battery cells can quickly be transmitted and spread to other battery cells arranged in a battery module, which can easily develop into a major fire accident.

The aforementioned information disclosed in this background section is merely for enhancement of understanding of the background technology of the present disclosure.

### SUMMARY

Embodiments include a busbar holder. The busbar holder includes a holder base configured to support a plurality of busbars, each busbar electrically connecting a pair of adjacent battery cells among a plurality of battery cells, and an insulator which is fixed to the holder base and includes a plurality of cell vent covering portions configured to cover a plurality of cell vents provided to face a first direction in the plurality of battery cells and be ruptured when gases are discharged from inside to outside of the battery cells through the plurality of cell vents.

The insulator may include one of mica, an aerogel, and a ceramic.

The holder base and the insulator may be joined.

The busbar holder may be molded and may include the holder base with the insulator inserted therein.

The plurality of cell vent covering portions may include a slot passing through the insulator in a thickness direction.

The plurality of battery cells and the plurality of busbars may be arranged in a second direction intersecting the first direction, wherein the plurality of cell vent covering portions may be arranged in the second direction to be spaced apart from the plurality of busbars, and the holder base may include a blocking wall extending in the second direction between the plurality of cell vent covering portions and the plurality of busbars, the blocking wall protruding away from the plurality of battery cells.

The insulator may further include an insulating plate portion connected to the plurality of cell vent covering portions, and a blocking wall insertion portion that may be bent and extends from the insulating plate portion away from the plurality of battery cells to be inserted into the blocking wall.

The plurality of battery cells may be arranged in a second direction intersecting the first direction, wherein the busbar holder may further include a plurality of separation partition walls, each of the plurality of separation partition walls protruding to be interposed between a pair of adjacent battery cells among the plurality of battery cells.

Embodiments include a battery module. The battery module includes a plurality of battery cells, each of the plurality of battery cells including a cell vent provided to face a first direction, resulting in a plurality of cell vents, a plurality of busbars, each of the plurality of busbars electrically connecting a pair of adjacent battery cells among the plurality of battery cells, and a busbar holder including a holder base supporting the plurality of busbars, and an insulator which is fixed to the holder base and includes a plurality of cell vent covering portions configured to cover the plurality of cell vents and be ruptured when gases are discharged from inside to outside of the plurality of battery cells through the plurality of cell vents.

The insulator may include one of mica, an aerogel, and a ceramic.

The holder base and the insulator may be joined.

The busbar holder may be molded and the insulator may be inserted into the holder base.

A slot passing through the insulator in a thickness direction may be formed in each cell vent covering portion.

Each cell vent covering portion may include at least one slot passing through the insulator in a thickness direction.

The at least one slot may include a plurality of slots, and the plurality of slots may extend along a plurality of cutting lines intersecting each other.

The plurality of battery cells and the plurality of busbars may be arranged in a second direction intersecting the first direction, the plurality of cell vent covering portions may be arranged in the second direction to be spaced apart from the plurality of busbars, and the holder base may include a blocking wall extending in the second direction between the plurality of cell vent covering portions and the plurality of busbars and protruding away from the plurality of battery cells.

The insulator may further include an insulating plate portion connected to the cell vent covering portion, and a blocking wall insertion portion that is bent and extends from the insulating plate portion away from the plurality of battery cells to be inserted into the blocking wall.

A side surface of the insulating plate portion may be exposed to face the plurality of battery cells.

The plurality of battery cells may be arranged in a second direction intersecting the first direction, and the busbar holder may further include a plurality of separation partition walls, each of the plurality of separation partition walls protruding to be interposed between a pair of adjacent battery cells among the plurality of battery cells.

The battery module may further include an adhesive layer between the busbar holder and the plurality of battery cells, wherein the busbar holder may be attached to the plurality of battery cells.

The battery module may further include a pair of side plates, wherein the plurality of battery cells may be interposed between the pair of side plates and to which the busbar holder is coupled.

These and other aspects and features of the present disclosure will be described in or will be apparent from the following description of some embodiments of the present disclosure.

However, the effects obtainable through the present disclosure are not limited to the above effects, and other technical effects that are not mentioned will be clearly understood by those of ordinary skill in the art from the following description of the present disclosure.

### BRIEF DESCRIPTION OF THE DRAWINGS

Features will become apparent to those of ordinary skill in the art by describing in detail exemplary embodiments with reference to the attached drawings, in which:

FIG. 1 is a perspective view of a battery module according to one or more embodiments of the present disclosure;

FIG. 2 is a top exploded perspective view of the battery module according to one or more embodiments of the present disclosure;

FIG. 3 is a bottom exploded perspective view of the battery module according to one or more embodiments of the present disclosure;

FIG. 4 is a side view illustrating a plurality of battery cells, a busbar holder, and a plurality of busbars extracted from the exploded perspective view of FIG. 2 according to one or more embodiments of the present disclosure;

FIG. 5 is a cross-sectional view along line A-A of FIG. 1 according to one or more embodiments of the present disclosure;

FIG. 6 is a top perspective view of a busbar holder according to one or more embodiments of the present disclosure;

FIG. 7 is a bottom perspective view of the busbar holder according to one or more embodiments of the present disclosure;

FIG. 8 is a cross-sectional view along line B-B of FIG. 6 according to one or more embodiments of the present disclosure;

FIG. 9 is a perspective view illustrating an insulator of FIG. 8 according to one or more embodiments of the present disclosure;

FIG. 10 is a plan view of a busbar according to one or more embodiments of the present disclosure;

FIG. 11 is a bottom view of the busbar holder according to one or more embodiments of the present disclosure; and

FIG. 12 is a cross-sectional view along line C-C of FIG. 10 according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

The same reference numerals designate the same or like elements throughout. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

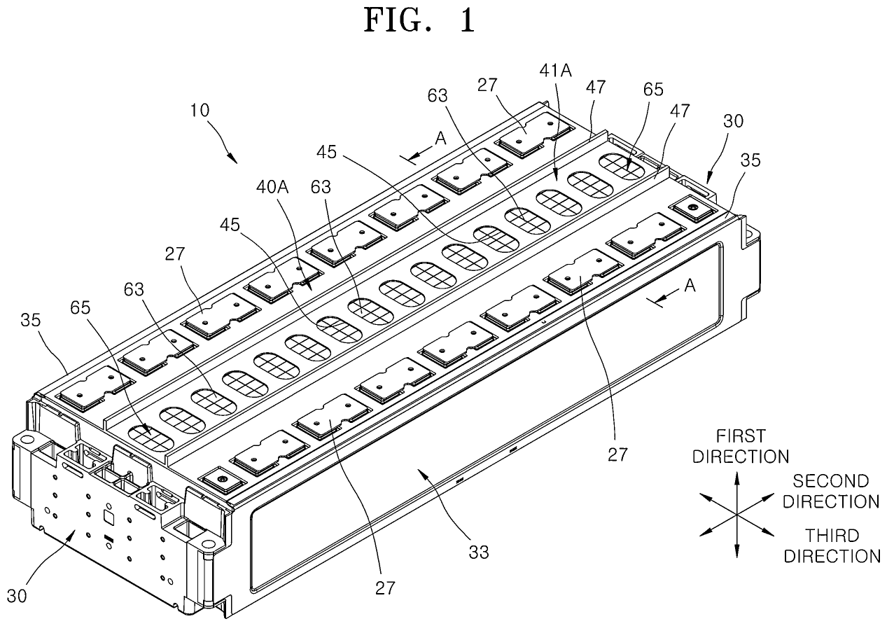

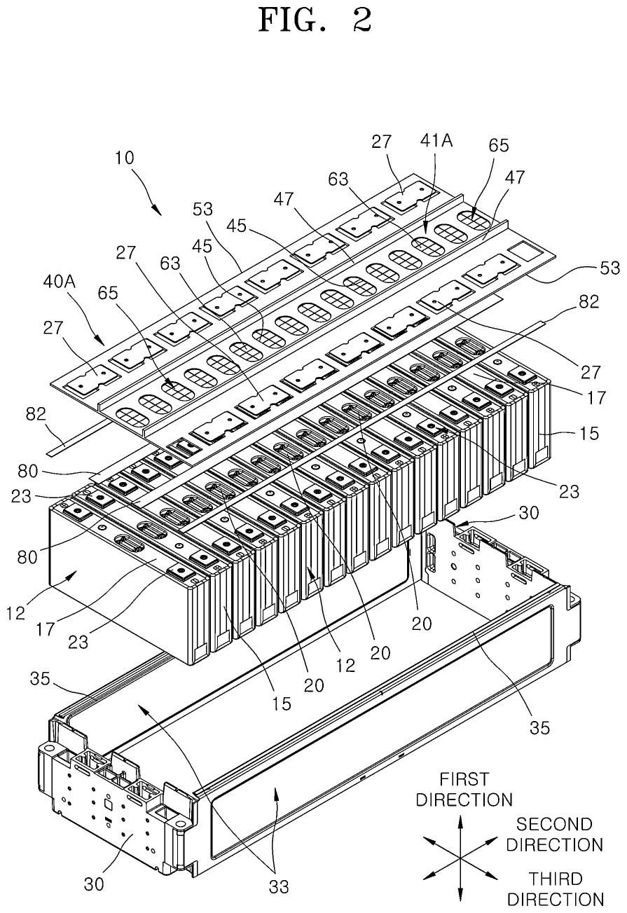

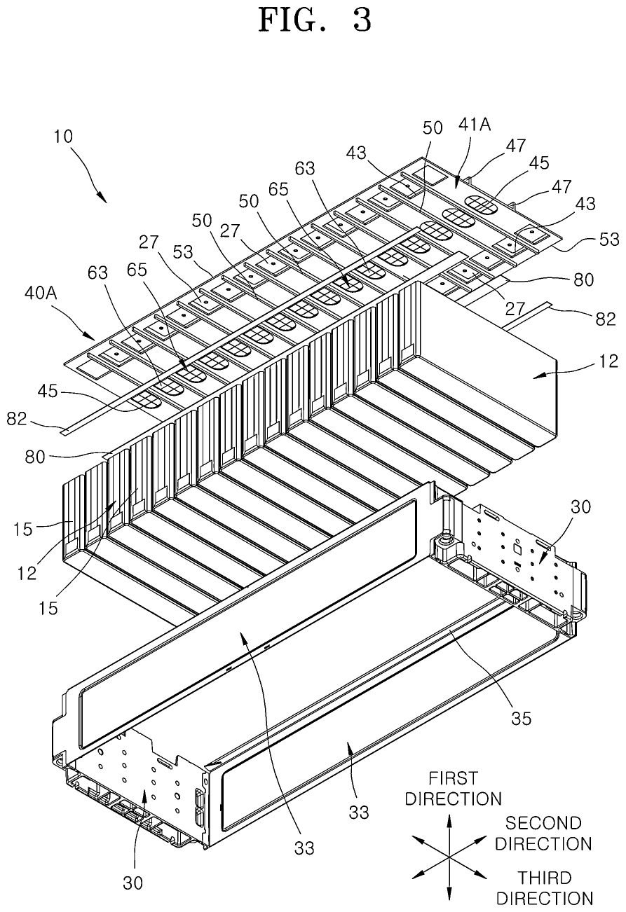

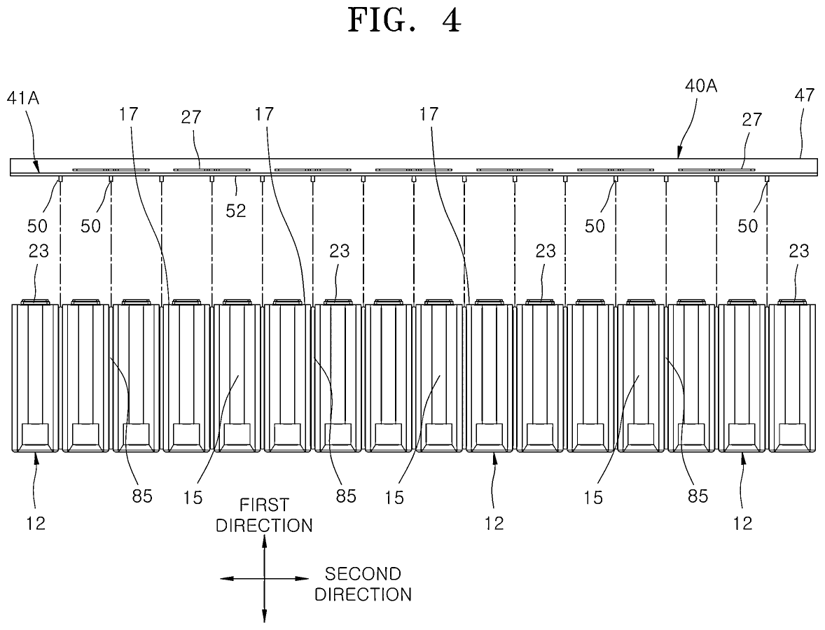

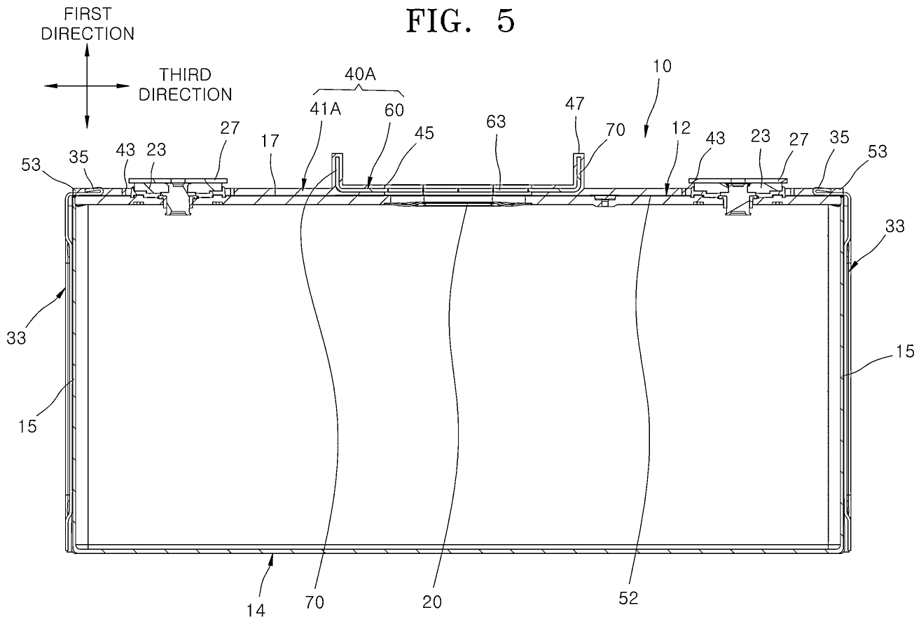

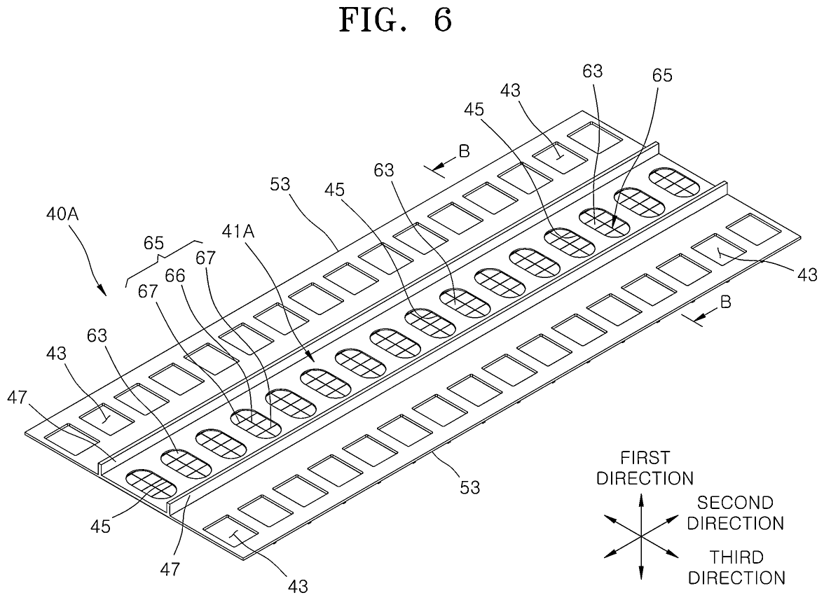

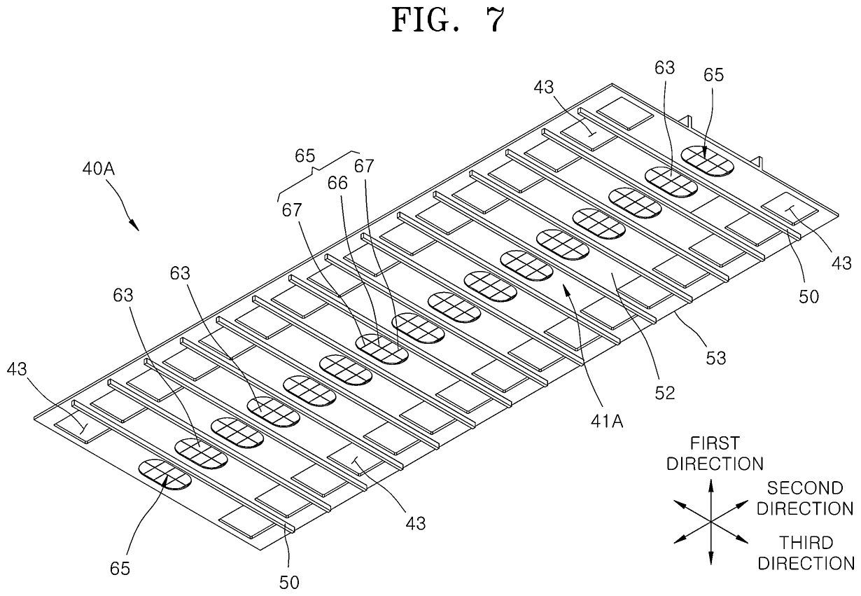

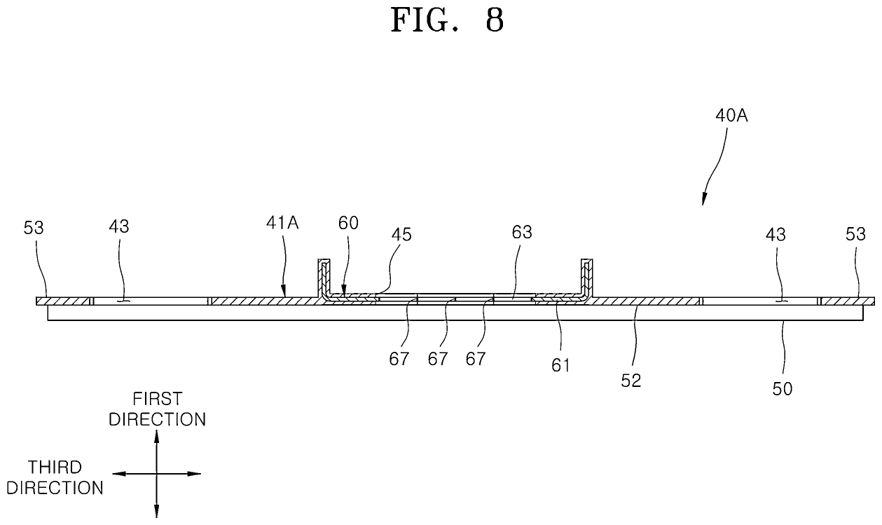

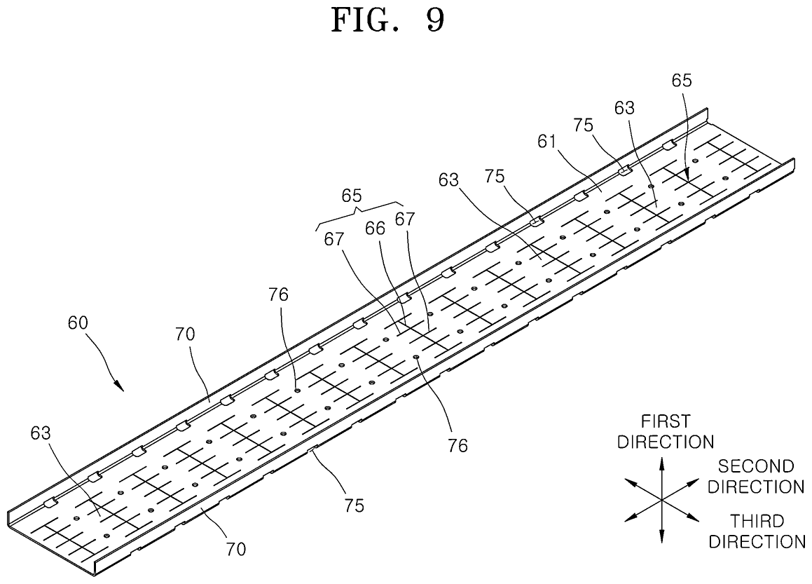

FIG. 1 is a perspective view of a battery module according to one or more embodiments of the present disclosure. FIG. 2 is a top exploded perspective view of the battery module according to one or more embodiments of the present disclosure. FIG. 3 is a bottom exploded perspective view of the battery module according to one or more embodiments of the present disclosure. FIG. 4 is a side view illustrating a plurality of battery cells, a busbar holder, and a plurality of busbars extracted from the exploded perspective view of FIG. 2 according to one or more embodiments of the present disclosure. FIG. 5 is a cross-sectional view along line A-A of FIG. 1 according to one or more embodiments of the present disclosure. FIG. 6 is a top perspective view of a busbar holder according to one or more embodiments of the present disclosure. FIG. 7 is a bottom perspective view of the busbar holder according to one or more embodiments of the present disclosure. FIG. 8 is a cross-sectional view along line B-B of FIG. 6 according to one or more embodiments of the present disclosure. FIG. 9 is a perspective view illustrating an insulator of FIG. 8 according to one or more embodiments of the present disclosure.

Referring to FIGS. 1 to 8, a battery module 10 according to one or more embodiments of the present disclosure may include a plurality of battery cells 12, a plurality of busbars 27, and a busbar holder 40A. Each of the plurality of battery cells 12 may include a cell vent 20. Each battery cell 12 may further include a cell case 14, a pair of cell terminals 23, and an electrode assembly (not shown).

The electrode assembly may be accommodated inside the cell case 14. The electrode assembly may be formed by winding or stacking a stack of a first electrode plate, a separator, and a second electrode plate, wherein the stack may be formed in a thin plate shape or a film shape.

If the electrode assembly is a wound stack, a winding axis may be parallel to a longitudinal direction of the cell case 14. In addition, the electrode assembly may be a stack type rather than a wound type, and the shape of the electrode assembly is not limited in the present disclosure. In addition, the electrode assembly may be a Z-stack electrode assembly in which a positive electrode plate and a negative electrode plate are inserted into both sides of a separator bent into a Z-stack. In addition, one or more electrode assemblies may be stacked such that long side surfaces thereof are adjacent to each other and may be accommodated inside a case, and the number of electrode assemblies is not limited in the present disclosure. The first electrode plate of the electrode assembly may serve as a negative electrode, and the second electrode plate may serve as a positive electrode. Of course, the reverse is also possible.

The first electrode plate may be formed by applying a first electrode active material such as graphite or carbon on a first electrode current collector plate made of a metal foil of copper, a copper alloy, nickel, a nickel alloy, or the like and may include a first electrode tab (or a first uncoated portion) that is an area on which the first electrode active material is not applied. The first electrode tab may serve as a path for current flow between the first electrode plate and a first current collector. In some examples, when the first electrode plate is manufactured, the first electrode tab may be formed by being cut in advance to protrude to one side. The first electrode tab may protrude to one side further than the separator without separate cutting.

The second electrode plate may be formed by applying a second electrode active material such as a transition metal oxide on a second electrode current collector plate made of a metal foil of aluminum or an aluminum alloy and may include a second electrode tab (or a second uncoated portion) that is an area on which the second electrode active material is not applied. The second electrode tab may serve as a path for current flow between the second electrode plate and a second current collector. In some embodiments, during manufacturing of the second electrode plate, a second electrode tab may be formed by being cut in advance to protrude to the other side. The second electrode tab may protrude to the other side further than the separator without separate cutting.

In some embodiments, the first electrode tab may be positioned on a side surface of a left end portion of the electrode assembly, and the second electrode tab may be positioned on a side surface of a right end portion of the electrode assembly. Alternatively, the first electrode tab and the second electrode tab may be positioned on one surface in the same direction. Here, the left side and the right side are for convenience of description, and the position of the battery cell 12 may be changed when the battery cell 12 rotates laterally or vertically.

Each of the first electrode tab of the first electrode plate and the second electrode tab of the second electrode plate is positioned at one of both end portions of the electrode assembly as described above. In some embodiments, the electrode assembly may be accommodated in a case along with an electrolyte. In addition, in the electrode assembly, the first current collector and the second current collector may be positioned to be respectively welded and connected to the first electrode tab of the first electrode plate and the second electrode tab of the second electrode plate which are exposed at both sides.

The cell case 14 may have an approximately rectangular parallelepiped shape and may accommodate the electrode assembly and the electrolyte therein. The cell case 14 may include a metal can of which one side is open and a cap plate which closes the one open side of the metal can. A pair of cell terminals 23 may be installed on the cap plate to protrude outward from the cap plate.

One cell terminal 23 of the pair of cell terminals 23 may be electrically connected to one of the first and second current collectors, and the other cell terminal 23 may be electrically connected to the other current collector of the first and second current collectors. Accordingly, the one cell terminal 23 of the pair of cell terminals 23 may become a positive electrode terminal, and the other cell terminal 23 may become a negative terminal.

The pair of cell terminals 23 for each battery cell may be positioned at both end portions of the cap plate in a longitudinal direction, and the cell vent 20 may be positioned between the pair of cell terminals 23 in the cap plate. If high-temperature gases or flammable materials are generated inside the cell case 14 due to overcharging or abnormal operations, the cell vent 20 is ruptured to discharge emissions such as gases or flammable materials from inside to outside of the cell case 14.

The battery cell 12 may be a prismatic battery cell in which the pair of cell terminals 23 protrude from an outer surface 17 of the cap plate in which the cell vent 20 is formed. Hereinafter, the outer surface 17 of the cap plate will be referred to as a cell vent side surface 17. A plurality of cell vents 20 may be provided in the cell case 14 to face a first direction.

The plurality of battery cells 12 may be arranged in one line in a second direction. Accordingly, the plurality of cell vents 20 may be arranged in one line in the second direction. Each cell case 14 may include a pair of cell side surfaces 15 at both sides in a third direction. The second direction may be a direction orthogonal to the first direction, and the third direction may be a direction orthogonal to the first and second directions. For example, the first direction may be an up-down direction, the second direction may be a front-rear direction, and the third direction may be a left-right direction.

Each of the plurality of busbars 27 electrically connects a pair of adjacent battery cells 12 among the plurality of battery cells 12. Each busbar 27 may extend in parallel to the second direction. Each busbar 27 may be in contact with a positive electrode cell terminal 23 of one battery cell 12 of the pair of battery cells 12 adjacent in the second direction and a negative electrode cell terminal 23 of the other battery cell 12 to electrically connect the positive electrode cell terminal 23 and the negative electrode cell terminal 23.

The plurality of busbars 27 may extend in the second direction and may be arranged in two lines along two imaginary lines spaced apart from each other. The plurality of cell vents 20 may be arranged in one line and disposed between the plurality of busbars 27 arranged in two rows.

The battery module 10 may further include a pair of end frames 30 and a pair of side plates 33. One end frame 30 of the pair of end frames 30 may be disposed in front of the plurality of battery cells 12 to cover a front surface of the battery cell 12 positioned in the forefront among the plurality of battery cells 12 arranged in the second direction.

The other end frame 30 of the pair of end frames 30 may be disposed behind the plurality of battery cells 12 to cover a rear surface of the battery cell 12 positioned rearmost among the plurality of battery cells 12 arranged in the second direction.

The pair of side plates 33 may each cover one of the pair of cell side surfaces 15 of the plurality of battery cells 12 and may each be disposed to face one of the cell side surfaces 15 and be in close contact therewith. Front and rear end portions of the pair of side plates 33 may be joined to both end portions of the pair of end frames 30 in the third direction through, for example, a method such as a welding method or a method of applying an adhesive.

The busbar holder 40A includes a holder base 41A and an insulator 60 (see FIGS. 5 and 8). The holder base 41A supports the plurality of busbars 27. A plurality of vent through-holes 45 are formed in the holder base 41A. The number of the plurality of vent through-holes 45 may correspond one-to-one to the number of the plurality of cell vents 20 of the plurality of battery cells 12. The plurality of vent through-holes 45 and the plurality of cell vents 20 may be disposed to be aligned in the first direction.

A plurality of terminal through-holes 43 may be formed in the holder base 41A. The number of the plurality of terminal through-holes 43 may correspond one-to-one to the number of the plurality of cell terminals 23 of the plurality of battery cells 12. The plurality of terminal through-holes 43 and the plurality of cell terminals 23 may be disposed to be aligned in the first direction (of FIG. 5).

If supported on the holder base 41A, the busbar 27 may be joined to the cell terminal 23 exposed through the terminal through-hole 43. The holder base 41A may be made of, for example, an insulating material such as synthetic resin to be insulated from the battery cell 12 and the busbar 27.

The insulator 60 may include a plurality of cell vent covering portions 63. The plurality of cell vent covering portions 63 cover the plurality of cell vents 20. The number of the plurality of cell vent covering portions 63 may correspond one-to-one to the number of the plurality of cell vents 20. The plurality of cell vent covering portions 63, the plurality of vent through-holes 45, and the plurality of cell vents 20 may be disposed to be aligned in the first direction.

When an abnormal phenomenon occurs inside the battery cell 12 and gases are discharged from the battery cell 12 to the outside through the cell vent 20, the cell vent covering portion 63 corresponding to the cell vent 20 is ruptured due to the pressure of the gases. Accordingly, high-temperature and high-pressure gases and flammable materials generated inside the battery cell 12 may be discharged through the ruptured cell vent covering portion 63 and the vent through-hole 45 without obstruction in the first direction, that is, to an upper side of the busbar holder 40A.

The insulator 60 is made of a material with excellent thermal resistance. For example, the insulator 60 may be made of one material of mica, an aerogel, and a ceramic. The insulator 60 may have properties of withstanding a temperature of 1,000° C. or more without being deformed for 10 seconds or more.

The insulator 60 may further include a flat insulating plate portion 61 connected to the plurality of cell vent covering portions 63. A slot 65 passing through the insulator 60 in a thickness direction may be formed in the cell vent covering portion 63 such that the cell vent covering portion 63 may be easily ruptured by the pressure of gases discharged from the cell vent 20.

A plurality of slots 65 may be provided. As shown in FIGS. 6, 7, and 9, the plurality of slots may include, for example, a first slot 66 extending along a first cutting line and three second slots 67 extending along a second cutting line intersecting the first cutting line. The first cutting line may be an imaginary line extending in the third direction, and the second cutting line may be an imaginary line extending in the second direction. The three second slots 67 may be disposed to be spaced apart from each other.

Meanwhile, instead of the slot 65, a dotted line passing through the insulator 60 in the thickness direction or a groove in which a thickness of the insulator 60 gradually becomes thinner may be formed in the cell vent covering portion 63.

The insulator 60 is fixed to the holder base 41A. As shown in FIG. 8, for example, the busbar holder 40A may be molded and formed by inserting the insulator 60 into the holder base 41A. In other words, in a state in which the insulator 60 is fixed inside a mold (not shown) for forming the holder base 41A, a synthetic resin may be injected into the mold and cured to form the busbar holder 40A.

A plurality of mold fixing through-holes 75 and 76 may be formed in the insulator 60 such that the insulator 60 may be fixed inside the above-described mold. Through-holes (not shown) corresponding to the mold fixing through-holes 75 and 76 of the insulator 60 may also be formed in a surface of the holder base 41A which is formed by injecting the synthetic resin into the mold and curing the synthetic resin.

In the case of a busbar holder according to another embodiment of the present disclosure, a holder base and an insulator may be joined by applying an adhesive rather than by insertion injection molding.

The holder base 41A may further include a pair of blocking walls 47 extending along the second direction between the plurality of cell vent covering portions 63 and the plurality of busbars 27 and may protrude away from the plurality of battery cells 12. For example, the blocking walls 47 may be formed between the plurality of cell vent covering portions 63 extending in one line and the plurality of terminal through-holes 43 extending in one line and between the plurality of cell vent covering portions 63 extending in one line and the plurality of terminal through-holes 43 extending in another line.

Although not shown in the drawings, the battery module 10 may further include a module cover which covers the busbar holder 40A such that the plurality of busbars 27 are not exposed upward and is coupled to the busbar holder 40A. Ends of the pair of blocking walls 47 in the first direction may be in close contact with a bottom surface of the module cover.

A chamber in which gases and flammable materials discharged from the cell vent 20 are accommodated may be formed by the module cover and the pair of blocking walls 47 spaced apart from each other such that the plurality of cell vent covering portions 63 are disposed therebetween. Gases and flame materials discharged due to the rupture of one cell vent covering portion 63 of the plurality of cell vent covering portions 63 may be blocked by the pair of blocking walls 47 and accommodated in the above-described chamber without moving to the busbar 27 and the cell terminal 23, thereby suppressing the propagation of fire.

The insulator 60 may further include a pair of blocking wall insertion portions 70 (see FIGS. 5 and 9) that are bent and extend from the insulating plate portion 61 (see FIGS. 8 and 9) away from the plurality of battery cells 12 to be inserted into the pair of blocking walls 47. The pair of blocking wall insertion portions 70 may protrude in the first direction from both ends of the insulating plate portion 61 in the third direction.

Since the pair of blocking wall insertion portions 70 are inserted into the pair of blocking walls 47, the rigidity of the pair of blocking walls 47 can be improved. In addition, even if the blocking walls 47 are made of a synthetic resin and are deformed or melted by high-temperature gases and flammable materials, the blocking wall insertion portions 70 can withstand the high-temperature gases and flammable materials without being deformed so that the propagation of fire can be suppressed and delayed.

The busbar holder 40A may further include a plurality of separation partition walls 50 (see FIG. 7), which may each protrude to be interposed between a pair of adjacent battery cells 12 among the plurality of battery cells 12. Specifically, the plurality of separation partition walls 50 may protrude from a bottom surface 52 of the holder base 41A. The separation partition walls 50 may protrude in a direction opposite to a direction in which the blocking walls 47 protrude.

Each of the plurality of separation partition walls 50 may extend in the third direction. A pair of adjacent separation partition walls 50 may be spaced apart from each other at an interval equal to a width of the cell case 14 in the first direction. Due to the separation partition walls 50, gases and flammable materials discharged from the cell vent 20 may not flow back toward the cell case 14. Accordingly, the propagation of fire can be further delayed and suppressed.

The battery module 10 may further include a plurality of insulating papers 85 (see FIG. 4) each interposed between a pair of adjacent cell cases 14 of the plurality of battery cells 12. The insulating papers 85 may be partially superimposed or in contact with the separation partition walls 50. Accordingly, the propagation of fire can be further delayed and suppressed.

The battery module 10 may further include adhesive layers 80 and 82 (see FIGS. 2 and 3) interposed between the busbar holder 40A and the plurality of battery cells 12 such that the busbar holder 40A is attached to the plurality of battery cells 12. The adhesive layers 80 and 82 may be formed by applying an adhesive or attaching double-sided adhesive tape.

A pair of first adhesive layers 80 may be formed to extend in the second direction between the cell vent 20 and the cell terminal 23 on the cell vent side surface 17. The pair of first adhesive layers 80 may be formed to be spaced apart from each other with the cell vent 20 interposed therebetween. One side surface of each of the pair of first adhesive layers 80 may be attached to the cell vent side surfaces 17 of the plurality of battery cells 12, and the other side surface of each of the pair of first adhesive layers 80 may be attached to the bottom surface 52 of the holder base 41A.

The cell vent side surface 17 around the cell vent 20 and the bottom surface 52 of the busbar holder 40A may be firmly fixed by the pair of first adhesive layers 80. Since a gap through which a fluid may flow disappears between the cell vent side surface 17 and the bottom surface of the busbar holder 40A, gases and flammable materials discharged from the cell vent 20 cannot flow back toward the cell case 14.

A pair of second adhesive layers 82 may be formed to extend in the second direction on the cell vent side surface 17 outside a pair of cell terminals 23 spaced apart from each other in the third direction. One side surface of each of the pair of second adhesive layers 82 may be attached to the cell vent side surfaces 17 of the plurality of battery cells 12, and the other side surface of each of the pair of second adhesive layers 82 may be attached to the bottom surface 52 of the holder base 41A.

The busbar holder 40A may be firmly fixed to the pair of side plates 33. For example, the pair of side plates 33 may include an upper coupling portion 35, which is bent toward the cell terminal 23, at an upper end portion. Both end portions of the busbar holder 40A in the third direction may be pressed by a pair of upper coupling portions 35 in a direction in which the upper coupling portions 35 come into close contact with the cell vent side surface 17.

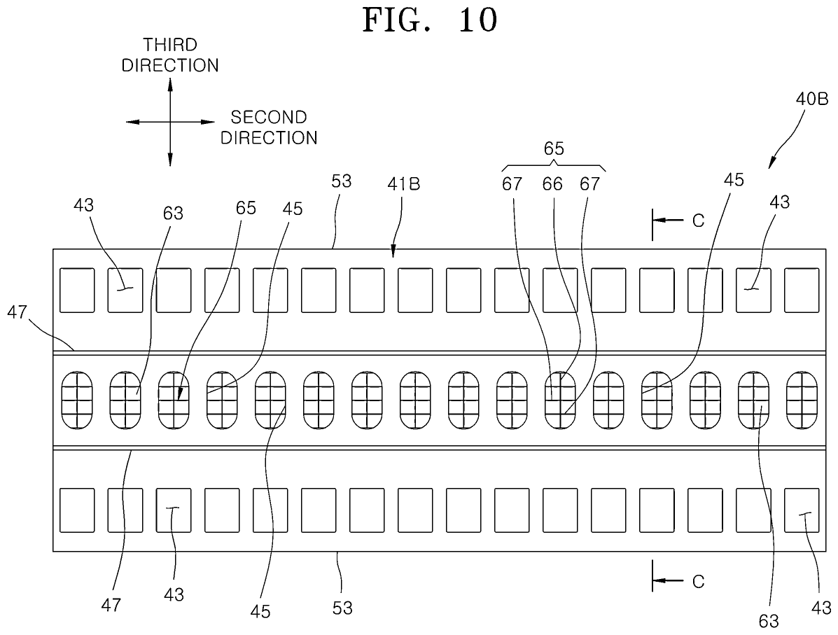

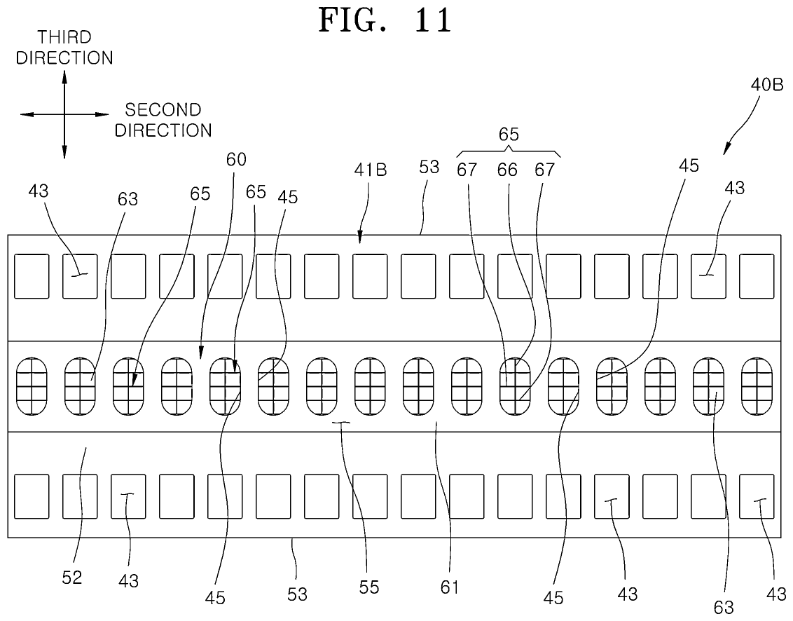

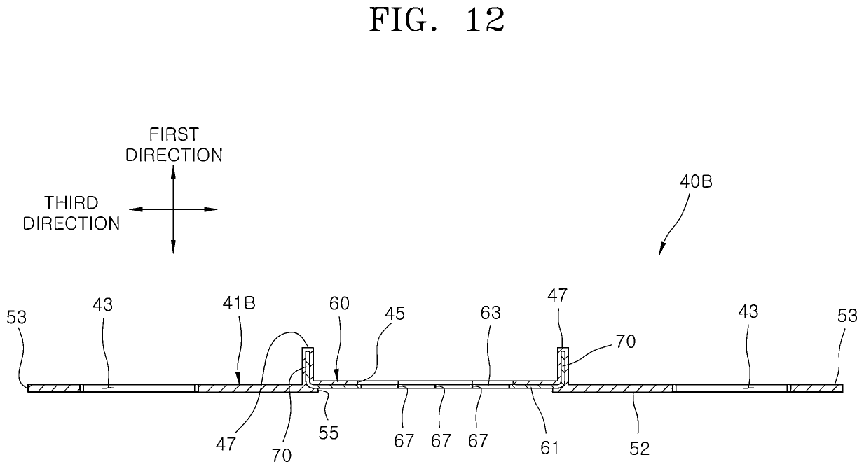

FIG. 10 is a plan view of a busbar holder according to a second embodiment of the present disclosure. FIG. 11 is a bottom view of the busbar holder according to the second embodiment of the present disclosure. FIG. 12 is a cross-sectional view along line C-C of FIG. 10. Referring to FIGS. 1 to 3 and 10 to 12, a busbar holder 40B according to the second embodiment of the present disclosure may be installed in the battery module 10 shown in FIGS. 1 to 3 instead of the busbar holder 40A according to the first embodiment of the present disclosure.

The busbar holder 40B according to the second embodiment of the present disclosure may include a holder base 41B and an insulator 60 like the busbar holder 40A according to the first embodiment of the present disclosure, and the holder base 41B includes a plurality of terminal through-holes 43, a plurality of vent through-holes 45, two end portions 53, and a pair of blocking walls 47.

The insulator 60, the plurality of terminal through-holes 43, the plurality of vent through-holes 45, the two end portions 53, and the pair of blocking walls 47 are indicated by the same reference numerals and have the same characteristics as the insulator 60, the plurality of terminal through-holes 43, the plurality of vent through-holes 45, the two end portions 53, and the pair of blocking walls 47 included in the busbar holder 40A according to the first embodiment of the present disclosure, and thus redundant description will be omitted.

A side surface of an insulating plate portion 61 of the insulator 60 facing a plurality of battery cells 12, that is, a bottom surface (see FIG. 11), may be exposed to face the plurality of battery cells 12. An insulator exposure window 55 from which a synthetic resin is removed may be formed on a bottom surface 52 (see FIG. 12) of the holder base 41B such that the bottom surface of the insulating plate portion 61 is exposed to face the plurality of battery cells 12.

Due to such a configuration, when high-temperature gases and flammable materials are discharged through a cell vent 20, since the high-temperature gases and flammable materials are discharged through a ruptured cell vent covering portion 63 immediately after coming into direct contact with the insulating plate portion 61 and a cell vent covering portion 63 which have excellent thermal resistance, a bottom surface of the holder base 41B may not be deformed or melted.

According to embodiments of the present disclosure, gases and flammable materials discharged due to the occurrence of an abnormal phenomenon in some battery cells included in a battery module are blocked by an insulator and do not spread to other surrounding battery cells. Therefore, the propagation and spread of fire and explosions in the battery module are delayed, thereby reducing damage to life and property.

According to embodiments of the present disclosure, when an abnormal phenomenon occurs in some battery cells included in a battery module and gases and flammable materials are discharged, a cell vent covering portion facing a cell vent through which gases are discharged is ruptured to allow the gases and flammable materials to be discharged smoothly, and a cell vent covering portion facing a cell vent of another battery cell in which an abnormal phenomenon does not occur is not ruptured. Therefore, the propagation of fire to other battery cells due to high-temperature gases and flammable materials is suppressed.

However, the effects that can be achieved through the present disclosure are not limited to the above-mentioned effects, and other technical effects that are not mentioned will be clearly understood by those of ordinary skill in the art from the description of the embodiments herein.

The present disclosure has been described with regard to a limited number of embodiments and drawings, but the present disclosure is not limited thereto and it is obvious to those skilled in the art that various modifications and changes may be made thereto within the technical spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A busbar holder comprising:
a holder base configured to support a plurality of busbars, each busbar electrically connecting a pair of adjacent battery cells among a plurality of battery cells; and
an insulator which is fixed to the holder base and includes a plurality of cell vent covering portions configured to cover a plurality of cell vents provided to face a first direction in the plurality of battery cells and be ruptured when gases are discharged from inside to outside of the plurality of battery cells through the plurality of cell vents.

2. The busbar holder as claimed in claim 1, wherein the insulator includes one of mica, an aerogel, and a ceramic.

3. The busbar holder as claimed in claim 1, wherein the holder base and the insulator are joined with an adhesive.

4. The busbar holder as claimed in claim 1, wherein the busbar holder is molded and includes the holder base with the insulator inserted therein.

5. The busbar holder as claimed in claim 1, wherein the plurality of cell vent covering portions includes a slot passing through the insulator in a thickness direction.

6. The busbar holder as claimed in claim 1, wherein:
the plurality of battery cells and the plurality of busbars are arranged in a second direction intersecting the first direction,
the plurality of cell vent covering portions are arranged in the second direction to be spaced apart from the plurality of busbars, and
the holder base includes a blocking wall extending in the second direction between the plurality of cell vent covering portions and the plurality of busbars, the blocking wall protruding away from the plurality of battery cells.

7. The busbar holder as claimed in claim 6, wherein the insulator further includes an insulating plate portion connected to the plurality of cell vent covering portions, and a blocking wall insertion portion that is bent and extends from the insulating plate portion away from the plurality of battery cells to be inserted into the blocking wall.

8. The busbar holder as claimed in claim 1, wherein the plurality of battery cells are arranged in a second direction intersecting the first direction, and wherein the busbar holder further includes a plurality of separation partition walls, each of the plurality of separation walls protruding to be interposed between a pair of adjacent battery cells among the plurality of battery cells.

9. A battery module comprising:
a plurality of battery cells, each of the plurality of battery cells including a cell vent provided to face a first direction, resulting in a plurality of cell vents;
a plurality of busbars, each of the plurality of busbars electrically connecting a pair of adjacent battery cells among the plurality of battery cells; and
a busbar holder including a holder base supporting the plurality of busbars, and an insulator which is fixed to the holder base and includes a plurality of cell vent covering portions configured to cover the plurality of cell vents and be ruptured when gases are discharged from inside to outside of the plurality of battery cells through the plurality of cell vents.

10. The battery module as claimed in claim 9, wherein the insulator includes one of mica, an aerogel, and a ceramic.

11. The battery module as claimed in claim 9, wherein the holder base and the insulator are joined with an adhesive.

12. The battery module as claimed in claim 9, wherein the busbar holder is molded and includes the holder base with the insulator inserted therein.

13. The battery module as claimed in claim 9, wherein each cell vent covering portion includes at least one slot passing through the insulator in a thickness direction.

14. The battery module as claimed in claim 13, wherein the at least one slot includes a plurality of slots, and wherein the plurality of slots extend along a plurality of cutting lines intersecting each other.

15. The battery module as claimed in claim 9, wherein:
the plurality of battery cells and the plurality of busbars are arranged in a second direction intersecting the first direction,
the plurality of cell vent covering portions are arranged in the second direction to be spaced apart from the plurality of busbars, and
the holder base includes a blocking wall extending in the second direction between the plurality of cell vent covering portions and the plurality of busbars and protruding away from the plurality of battery cells.

16. The battery module as claimed in claim 15, wherein the insulator further includes an insulating plate portion connected to the cell vent covering portion, and a blocking wall insertion portion that is bent and extends from the insulating plate portion away from the plurality of battery cells to be inserted into the blocking wall.

17. The battery module as claimed in claim 16, wherein a side surface of the insulating plate portion is exposed to face the plurality of battery cells.

18. The battery module as claimed in claim 9, wherein:
the plurality of battery cells are arranged in a second direction intersecting the first direction, and
the busbar holder further includes a plurality of separation partition walls protruding to each be interposed between a pair of adjacent battery cells among the plurality of battery cells.

19. The battery module as claimed in claim 9, further including an adhesive layer between the busbar holder and the plurality of battery cells, wherein the busbar holder is attached to the plurality of battery cells.

20. The battery module as claimed in claim 9, further comprising a pair of side plates, wherein the plurality of battery cells are interposed between the pair of side plates and to which the busbar holder is coupled.
